(19) United States
(12) Patent Application Publication
(10) Pub. No.: US 2013/0179363 A1
(43) Pub. Date: Jul. 11, 2013

(54) FUNCTIONAL MODEL FOR RATING EVENTS

(71) Applicants: Emmanuel Texier, Sunnyvale, CA (US); Gireesh Malaksamudra, Sunnyvale, CA (US); Jens Kaemmerer, Mountain View, CA (US); Louis Piro, JR., San Jose, CA (US)

(72) Inventors: Emmanuel Texier, Sunnyvale, CA (US); Gireesh Malaksamudra, Sunnyvale, CA (US); Jens Kaemmerer, Mountain View, CA (US); Louis Piro, JR., San Jose, CA (US)

(73) Assignee: Oracle International Corporation, Redwood Shores, CA (US)

(21) Appl. No.: 13/346,396

(22) Filed: Jan. 9, 2012

(51) Int. Cl. G06Q 30/02

(52) U.S. Cl. 705/347

(57) ABSTRACT

Techniques are provided for implementing a rating engine that processes events about usage information regarding a product or service used by customers of the product/service. The rating engine represents a connected graph of objects whose function is to accept input (if necessary), perform one or more operations, and generate a result that is used to determine which other object to execute. The input might include information about an “event” that indicates usage information of the product/service by a particular customer. Because not all objects need to be executed to determine the appropriate response for some events, many computing resources can be used to process subsequent events.

### FIELD OF THE INVENTION

The present invention relates to rating an event that reflects an amount of usage of a service or product by a customer.

### BACKGROUND

“Rating” generally refers to the process of determining the cost or price of product or service usage. Rating might also refer to distributing or sharing a charge and alteration (or discounting). For example, many telecommunication carriers allow customers (or subscribers) to choose a particular plan, which may be a pre-paid plan or a post-paid plan, such as a monthly/yearly-based plan. Any usage by the customer of the service provided by the telecommunication carrier is reported to a rating engine. The rating engine may be maintained by the carrier or by a third party. The rating engine calculates, based on the customer's plan and the customer's usage, an amount to charge the customer or how much to report to the customer's account. The amount may be deducted from a total remaining usage amount (e.g., in minutes or gigabyte usage).

In the telecommunications context, a rating engine may take into account multiple factors, such as time of the usage (e.g., after 7 PM Pacific Standard Time), duration of the usage (e.g., 5 minute call), destination of a call (e.g., landline, overseas, friend or family), and origin of call or location of caller (e.g., roaming for mobile networks). In the Internet context, factors might include the amount of content downloaded (e.g., 5 gigabytes), the type of streaming content, the quality of the content, and the time of download.

Rate plans are becoming increasingly complex and are changing frequently. Rating engines, therefore, must be configured to process usage information against such complex and ever-changing rate plans. Typically, a rate plan designer (e.g., an employee of a telecommunications carrier) provides input at a user terminal (e.g., desktop computer, laptop computer, or tablet computer) that displays a user interface. The input reflects a set of rules that are used to calculate an amount (e.g., in minutes, currency, or data usage) that is used to keep track of a customer's usage. The user interface accepts the input and might generate an XML document (or other document in a tabular format) that reflects all the rules reflected in the input. One problem with such data-centric representations is that they are not suitable to express a rate plan. Alone, such representations cannot easily express the functional aspect of a rate plan, such as an if-then-else condition. As a result, conventional rating engines need to implement additional functional modules to process the data (such as a set of modules, hard-coded logic, or rule engines), as described later.

An “event” is data that is generated in response to a customer using a product or service. For example, an event is created when a customer completes a telephone call. Additionally, an event may be created when a customer begins the call and, optionally, at one or more points during the call.

A rating engine can process events in real-time or offline. Real-time processing is typically required when a customer, for example, makes a call or accesses the internet, and the rating engine needs to grant the access in real-time, so that the customer does not wait to use the service. A product or service provider (such as a telecommunications carrier) desires to process certain events in real-time (or as quickly as possible) for at least two reasons: revenue leakage and loss of opportunity. Revenue leakage refers to allowing more usage to a customer than the customer is entitled. Loss of opportunity refers to not granting an amount of usage to a customer when the customer is entitled to that amount. For example, in the prepaid telephone context, a customer has a limited number of minutes to communicate using a phone. A telecommunications carrier, with which the customer contracts or subscribes, does not want the customer to use more minutes than the customer is entitled to (i.e., based on the customer's contract). Therefore, if a customer has “used up” his/her minutes, then the telecommunications carrier does not want to allow the customer to make another call without first paying for additional minutes. To prevent customers from over using their minutes, the telecommunications carrier might turn down a usage request and wait for all events that have not yet rated to be rated. However, rating all outstanding events may take time and the denial of service to a customer that is entitled to that service will result in poor customer satisfaction. This loss of opportunity translates into loss of money for the carrier.

As another example, in the post-paid telephone context, a customer does not want to find out a day or more later that not only has she “used up” her minutes, but she also went over her limit by about an hour, which excess is charged at a significantly higher rate. Therefore, it is imperative that events are processed as quickly as possible so that a customer does not use more of the product or service to which the customer is entitled and, similarly, so that a customer is not prevented from using the product or service to the extent that the customer is entitled.

Some events can be processed offline (such as monthly billing). Those events do not need to be processed in real-time. However, a telecom provider needs to produce billing in a timely manner. For example, the provider might have to generate hundreds of millions of bills on the first day of every month. A fast rating engine will provide better user experience (bills are produced on time) and might prevent the provider from having to invest in a costly server infrastructure (because fewer servers are needed to process all the events). For online processing in real-time, not being able to process events in a timely manner (e.g., in a matter of a few milliseconds) might cause timeouts, errors, failures, etc. To avoid complete collapse of the system, providers allow the system to run in a degraded mode when the system is overloaded. In this mode, and based on some configured policies, the system might produce either pessimistic denials of service (loss of opportunity), or optimistic authorizations of service (revenue leakage).

However, current approaches to processing events are proving deficient. In one approach, a rating engine comprises a series of multiple (e.g., plug-in) modules. For each usage event of a customer, each of the modules is configured to make a certain determination based on the event and the customer's rate plan and provide a result to the next module in the series. For example, in rating a telephone call, one module may be configured to check whether the current date is the customer's birthday, another module may be configured to determine if the destination of the call is within the customer's “friends and family” group and, if so, how much to rate the call, and another module is configured to determine the time of the day and rate the call as if there are no exceptions, such as a birthday or the destination being certain friends or family. However, there are a number of disadvantages to using such an approach. For example, a context switch has to be performed each time a module in the series is finished and another module is executed. As another example, each module in the series is executed even though some modules may be unnecessary. Thus, computing resources (e.g., CPU cycles and memory) that could be used to process subsequent events must be employed to process a current event. When hundreds of thousands of events are created in a short window of time, such “wasted” computing resources become extremely valuable.

In another approach, a rating engine comprises a large set of rules against which an event is evaluated. In other words, for each event received at the rating engine, the rating engine evaluates the event against each rule. However, for many events, the evaluation of each event against each rule may be unnecessary. For example, if the evaluation of an event against a single rule results in a determination that the customer will not be charged, then evaluation of the event against each other rule in the set is unnecessary. Again, in this approach, computing resources are wasted.

In another approach, instead of using a series of modules or a large set of rules, a rate plan is “hard-coded” in that the rate plan is reflected in a single software module. However, service providers desire flexibility in offering different rate plans in order to respond to changing market conditions. Thus, a hard-coded solution may only be relevant for a short period of time, after which it may become obsolete. Providing a hard-coded solution for each new rate plan would be expensive and tedious. Furthermore, most product and service providers desire control over creating and testing the rate plans. However, requiring such providers to write the source code for each rate plan is undesirable.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts a rating graph that graphically represents an example rate plan functor, according to an embodiment of the invention;

FIG. 2 is a flow diagram that depicts a process for processing an event, according to an embodiment of the invention;

FIG. 3 is a block diagram that depicts an example memory representation of a rate plan functional object that comprises multiple functional objects, according to an embodiment of the invention; and

FIG. 4 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Techniques are provided for rating an event that indicates an amount of usage by a customer of a service or product. A rate plan is represented by rate graph “functor” (or functional object) that comprises a plurality of functional objects. The logic represented in the rate plan functor may be viewed as a decision (e.g., binary) tree. Information about an event is input to one of the functional objects (e.g., a “root” node), which generates a result. The result may dictate which functional object in the plurality is executed next. The set of functional objects that are executed in order to generate a final result may be less than all the functional objects in the rate plan functor. Embodiments offer a functional approach to describing rate plans: DSL expressions make it easy to represent both the data and functions (such as conditions and outcomes) that make up a rate plan.

Although examples provided herein refer to receiving and processing usage events that are generated in response to a user using an amount of a service or product, embodiments of the invention are not so limited. For example, events may be system events, such as a monthly billing cycle event. In response to receiving such a system event, an event processing system as disclosed herein processes the system event and might determine and return a charge that corresponds to, for example, a monthly rate, plus tax and miscellaneous fees.

### Domain Specific Language

A DSL is s a programming language or specification language that is dedicated to a particular problem domain. Creating a DSL (with software to support it) is worthwhile if the language allows a particular type of problem or solution to be expressed more clearly than pre-existing languages allow. Some goals of creating a DSL may include that the DSL is expressive, concise, extensible, easy to test, and optimized specifically for evaluating rating events.

In contrast, a current technique for expressing a rate plan involves a system that includes a user interface where a user can enter values in different fields. The fields and field values reflect the rules of a rate plan. The user interface accepts the inputs and generates a (relatively) large XML document (or other tabular representation) that reflects the rate plan. Such a user interface is required for users because the generic data representations (e.g., XML, or tabular representations) are not suitable for describing rate plans. Instead, such data representations tend to be verbose and lack expressiveness. During runtime, one or more modules of a rating engine access the, for example, XML document, analyze the XML data contained therein, and rate an event in light of the rules reflected in the XML data.

With a DSL for rating plans, because the DSL is so expressive, a UI is not required as a translation layer. Furthermore, a single DSL expression can describe both the data and rules of a rate plan, which is difficult, if not impossible, with data-centric representations. Additionally, the runtime model for DSL expressions can contain both data and function logic, while the runtime model for data-centric representations often only contains data. The runtime processing of a data-centric runtime model, on the other hand, is usually slower and un-optimized because such a model requires an additional system to run the functional logic. The additional system is usually the same for every rate plan expressed in a data-centric representation and, therefore, is not optimized.

According to an embodiment, a domain specific language (DSL) is created and used to express rate plans. The vocabulary of a DSL may be limited to those words that capture the core rating concepts. The DSL should be expressive enough for both programmers and domain experts to quickly learn. An example of a DSL statement is the following:

(dayOfYear==@birthday)=>linearRate(0.00)|+(@calledId<:@friendsAndFamily)=>linearRate(0.01)|+[20:00:00,07:00:00]=>linearRate(0.02)|+linearRate(0.05)

The vocabulary used in this DSL statement is specific to the rating domain. For example, “dayofYear” is a singleton that returns the current day of the current year; “@birthday” is an alias to a more complex DSL expression that determines the birthday of the customer that is associated with an event that is currently being processed; and “linearRate” is a function that accepts an input parameter value (e.g., “0.00”) and generates a value as output, where the value represents an amount to charge the customer. The “=>” symbol indicates that if the previous expression is true, then the immediately subsequent expression is evaluated. The “|+” symbol indicates that if the previous condition (e.g., “(dayOfYear=@birthday)”) is false, then the event is to be processed using a subsequent expression in the DSL statement. The “|+” symbol also indicates that a previous condition could be partially true and that the event is to be processed by a subsequent expression. For example, a customer calls a friend at 11:55 PM on the customer's birthday and the call lasts 10 minutes. According to the rate plan reflected in the example DSL statement above, the first five minutes of the call is free and the last five minutes will be rated according to the expressions after the first “|+” symbol.

A number of benefits are realized by creating a DSL specifically for expressing rate plans. One is that a designer or creator of a DSL statement is shielded from the internals of the event processing system. Another benefit is that the language is (a) more expressive than composing a XML document that reflects a rate plan and (b) much more expressive than writing source code (e.g., Java) for a hard-coded implementation of a rate plan. Another benefit is that testing a DSL statement is much easier than testing code.

A DSL statement may be written by a user, such as a designer of rate plans. Additionally or alternatively, a DSL statement may be automatically generated based on user input received through a user interface designed to accept input that reflects a rate plan. The input may be converted directly into a DSL statement or into an intermediary format, such as XML, and then from the intermediary format to a DSL statement.

The following is an example lexicon for a DSL that is created for expressing rate plans:

Operators: +, −, <, >, ==, |, &&, 3, <:, |+, ∥, !, =>

Singletons: start, end, dayOfYear, dayOfWeek, dayOfMonth, quantity, TRUE, FALSE

Other Functions: linearRate, fixedRate, fail, localDate, date, getObject, getBigDecimal, getBoolean

Aliases: @birthday, @dateOfBirth, @qos, @friendsAndFamily, @balance, @inputValue, @outputVolume, @cellHomeIds, @calledId, @cellId

Operators accept, as input, one or more operands, which may be functions themselves. Singletons are functions that do not require data from an event to generate an output. “Other functions” are functions that require, as input, data from or about an event in order to generate an output.

In an embodiment, a DSL created for expressing rate plans is extensible. In other words, additional functions may be supported, as long as a DSL parser for the DSL is extended to support the new vocabulary. Similarly, a DSL may be extensible in the creation of aliases. The example DSL statement above includes an alias, which resolves to a more complex DSL expression. For example, @birthday may be an alias for “getObject(“RatingContext#customer/birthday/toString?MMdd”)” where getObject is an example of an “other function” above. As functions become more complex, an alias may be added to a DSL to simplify the composition of DSL statements.

### Rate Plan Functor

According to an embodiment, a DSL parser accepts a DSL statement as input, parses the statement, and generates a rate plan functor, which may be viewed as a decision tree that conceptually represents the functional logic of the rate plan defined by the DSL statement. Thus, the DSL statement “modelizes” the rate plan functor in its own language. Indeed, each logical expression (whether the expression returns a Boolean value or rates an event) in the decision tree can correspond directly with an expression in the corresponding DSL statement. Because the DSL syntax is very similar to how a rate plan functor is viewed, it should be easy for the designer to use the DSL.

As a decision tree, a rate plan functor may be viewed as an ordered set of functions. Each function may be implemented as an object, such as a function object. A function object, also referred to as a “functor,” is a computer programming construct that allows an object to be invoked or called as though the object is an ordinary function, usually with the same syntax. Each function indicated in the example lexicon above (i.e., operators, singletons, other functions, and aliases) may be implemented as a functor. For aliases, at parse time, the DSL parser identifies, based on an alias, one or more functors and input(s) for the alias and generates the one or more functors.

In an embodiment, a rate plan functor is a binary tree where each node has at most two children (referred to herein as a “right-hand child” and a “left-hand child”). The connection from a parent node to a right-hand child may be modeled by the “=>” operator functor, and the connection from the parent node to a left-hand child may be modeled by a “|+” operator functor. The DSL parser generates a functor that is a combination of all the functors that are part of the DSL statement.

Non-leaf nodes of a rate plan functor are considered predicate or condition functors that evaluate to true or false (completely or partially). The conditions represented by predicate functors may be any condition. Such conditions may be based on the destination of a call, when the call is made, and how long the call lasts. For example, a condition may be on all or a part of a quantity to rate, which quantity may be a duration, such as “([20:00:00,07:00:00]).” Non-leaf nodes act as guards to their respective two children nodes. The right-hand child of a predicate node may receive as input the quantity on which the predicate is true. The left-hand child of a predicate node may receive as in input the quantity on which the predicate is false. Each child node of a predicate node is either a leaf node or another non-leaf (or branch) node, each of which are considered rate functors.

A leaf node is a rate functor that rates the quantity that is given to the leaf node as input and returns a result that typically contains the charge for that quantity (plus, for example, some other information related to the charge such as a general ledger assignment, tax code, etc.). For example, a rate functor may be generated for “linearRate(0.01).” A branch node may also be considered a rate functor, albeit a combination of multiple functors that together act as a rate functor. For example, the following may be considered a rate functor: “[20:00:00,07:00:00]=>linearRate(0.02)|+linearRate(0.05).” Furthermore, the rate plan functor as a whole can be considered as a branch (or a tree), which is also a rate functor. The result of executing a rate plan functor is the aggregation of all the charges resulting from the evaluation of each executed leaf node (a list of all single rate functors results), which may be a subset of all the leaf nodes in the rate plan functor.

In an embodiment, the connections between nodes are also functors, referred to herein as operator functors. Non-limiting examples of operator functors include ‘+’, ‘−’, ‘*’, ‘=>’ and ==. For example, ‘=>’ is a binary operator functor that takes a left-hand side operand (e.g., a predicate functor) and right-hand side operand (e.g., a rate functor). In other words, if the predicate functor (or left-hand side operand) is true, then the rate functor (or right-hand side operand) is executed. The evaluation of the rate functor returns a charge on a quantity (e.g., a duraction) if the left-hand side operand (or predicate functor) is true.

As another example, ‘|+’ is a binary operator functor that acts as an aggregator and takes two rate functors: a left-hand side (or simply “left”) rate functor and a right-hand side (or simply “right”) rate functor. This binary operator functor evaluates a charge produced by the left rate functor, and, if the quantity is not completely rated, this binary operator functor adds a charge produced by the right rate functor. Based on the foregoing, such a functional approach allows combining functors recursively to make more complex functors. For the purpose of expressiveness, the DSL parser is designed to accept constructs that look more like mathematical equations rather than unreadable recursive functions calls.

In an embodiment, a functor is an immutable object, i.e., whose state is not modified after its creation. In some cases, an object is considered immutable even if some internally-used attributes change but the object's state appears to be unchanging from an external point of view. For example, an object that uses memoization to cache the results of expensive computations may still be considered an immutable object. Thus, if a particular functor is called with certain input, then the result of executing the functor with that input may be cached or stored in association with (or in) the functor. Thus, the next time the functor is called with that input (e.g., in the context of another event that may be initiated by a different customer), the result is read without executing the logic of the functor. The result may also be passed as input to another functor. Other advantages of immutable objects include that immutable objects are easily shareable and composable and are thread-safe.

Thus, a rate plan functor is a functional object that contains all the logic and data (other than data required from the event itself) to rate an event. This feature of containing all the logic and data is another advantage compared to conventional runtime approaches, i.e., the functional runtime model makes the rate plan an executable object. Common approaches only consider the data representation of a rate plan, and require a separate rating engine to evaluate the rate plan. Such engines merely use the rate plan as a specification. In embodiments described herein, the rate plan functor is itself the engine.

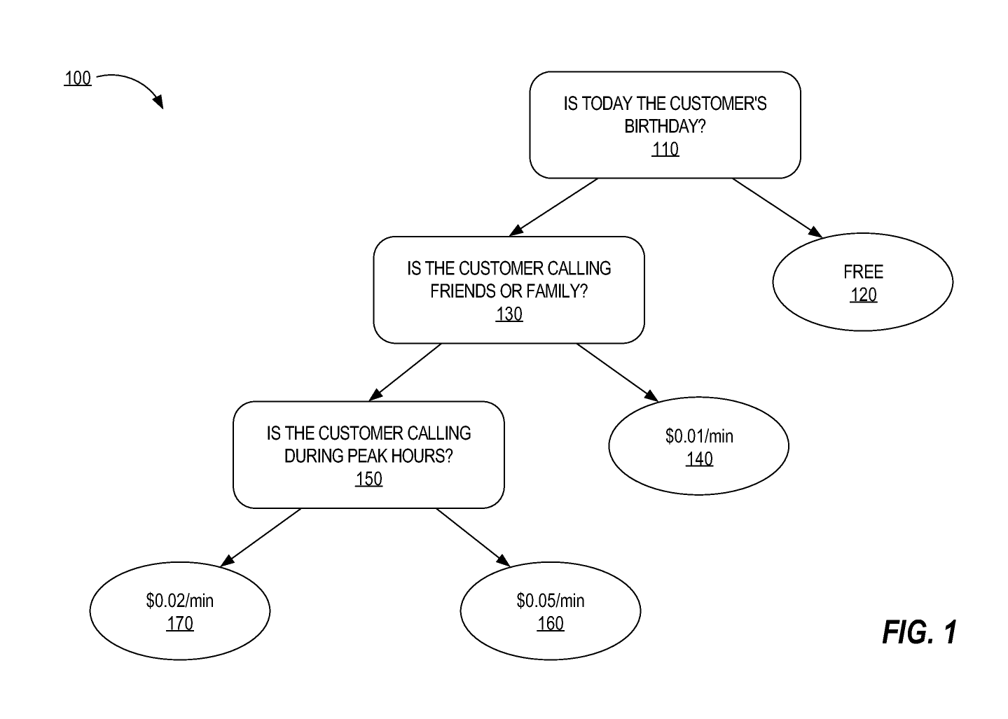

FIG. 1 is a block diagram that depicts an example rating graph 100 that graphical represents a rate plan functor, according to an embodiment of the invention. The leaf nodes represent different possible charges that may be calculated for a given event. Each node in rating graph 100 corresponds to a functor. Specifically, functor 110 answers the question, “Is today the customer's birthday?” If the answer to that question is “Yes,” then functor 120 is executed, which ensures that the customer is not charged for usage. If the answer to that question is “No,” then functor 130 is executed.

Functor 130 answers the question, “Is the customer calling friends or family?” If the answer to that question is “Yes,” then functor 140 is executed, which calculates a charge of $0.01 per minute. Thus, if the customer made a call to a recognized friend or family and the call lasted for 10 minutes, then functor 140 ensures that a charge of $0.10 is reflected on the customer's account. If the answer to that question is “No,” then functor 150 is executed.

Functor 150 answers the question, “Is he calling during peak hours?” If the answer to that question is “Yes” (for at least a portion of the duration of the call), then functor 160 is executed, which calculates a charge of $0.05 per minute (for at least the portion of the duration of the call that during peak hours). If the answer to that question is “No” (for at least a portion of the duration of the call) then functor 170 is executed, which calculates a charge of $0.02 per minute (for at least the portion of the duration of the call that was not during peak hours). In either outcome, the respective function ensures that the appropriate charge is reflected on an account of the customer.

### Processing an Event

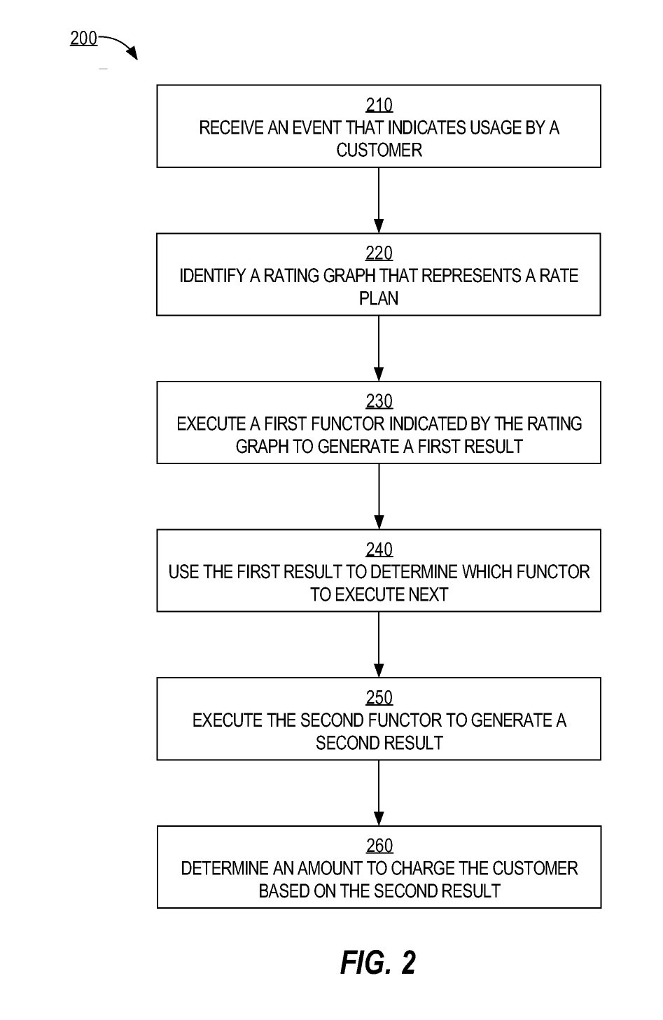

FIG. 2 is a flow diagram that depicts a process 200 for processing an event, according to an embodiment of the invention. Process 200 is performed by an event processing engine. Process 200 may be performed by a single process or different steps of 200 may be performed by different processes or different threads of the same process.

At step 210, an event that indicates usage by a customer is received.

At step 220, a rate plan functor that represents a rate plan is identified. If there are multiple rate plans, then the appropriate rate plan functor is first selected from among the multiple rate plans.

At step 230, a first functor indicated by the rate plan functor is executed to generate a first result. The first functor may represent the root node in the rate plan functor.

At step 240, the first result is to determine which functor to execute next. There may be two or more functors to call next (depending on the rating plan), after the result is evaluated. For example, if the result of executing function 110 in rating graph 100 is a Boolean true, then functor 120 (which does not require input) is executed. If the result of executing function 110 is a Boolean false, then functor 130 (which requires input about the customer who initiated the event) is executed.

At step 250, a second functor indicated by the rate plan functor is executed to generate a second result. The second result may be a Boolean value or, for example, an integer value. For example, if the second functor corresponds to functor 130, then the second result is a Boolean value. If the second functor corresponds to functor 120, then the second result is an integer value.

At step 260, an amount to charge the customer is determined based on the second result. In example rating graph 100, the result of executing functor 160 or functor 170 is considered to be “based on” the result of executing functor 130, even though the result of executing functor 130 is a Boolean value. The execution of functor 160 or functor 170 depends on the fact that the result of executing functor 130 indicates a false value.

Although this example only referred to functor evaluations, embodiments may include many more functor evaluations in response to a single event.

Advantages of using a rate plan functor (i.e., comprised of a set of functors) to rate an event (whether a usage event or a system event) include composability and reduced complexity. Reduced complexity (relative to current approaches for processing usage events) is achieved due to the “flat” class hierarchy of objects. In other words, every object in a rate plan functor may be a functor. There is no inheritance among the different functors.

With respect to composability, functors may be combined with other functors to form branches or trees that represent a more complex rule of a particular rate plan. Thus, a complex rate plan functor may be composed (or made up) of multiple “simple” functors. Composability is favored over inheritance, which is a feature of object-oriented programming and increases complexity.

A rate plan functor leverages mathematical properties, such as commutativity (i.e., changing the order of operands does not change the end result), associativity (i.e., changing the order in which the operations are performed does not change the end result), and distributivity. For example, the following DSL statement illustrates the distributive property of a rate graph functor that results from parsing the DSL statement:

(dayOfYear==@birthday)=>

(([07:00:00, 20:00:00]=>linearRate(0.05))

|+([20:00:00, 07:00:00]=>linearRate(0.01)))

which is equivalent to (i.e., yields the same result as)

(dayOfYear==@birthday)=>(([07:00:00, 20:00:00]=>linearRate(0.05))

|+(dayOfYear==@birthday)=>([20:00:00, 07:00:00]=>linearRate(0.01))

### Multiple Rate Plans

A product or service provider that processes (usage) events may offer, to potential customers, multiple rate plans from which to choose. Therefore, in an embodiment, multiple rate plan functors are generated, one for each rate plan. As indicated above, one source of the rate plan functors may be multiple DSL statements, composed by a designer of the rate plans. Additionally or alternatively, another source of rate plan functors may be a user interface through which a user enters rules (i.e., not in the form of DSL statements) that reflect a rate plan. The entered data is subsequently transformed into a DSL statement that reflects the rate plan.

Accordingly, in an embodiment, when an event arrives at an event processing engine, the event processing engine identifies a rate plan functor from among a plurality of rate plan functors, each rate plan functor corresponding to a different rate plan. The event may include rate plan data that indicates a rate plan that the customer (who initiated the event) previously selected. Alternatively, the event may simply indicate a customer identifier, which may be associated (e.g., in a customer-to-rate plan table) with a particular rate plan. Thus, the event processing engine may identify a rate plan associated with the customer, identify a rate plan functor associated with the rate plan, and pass the event to the rate plan functor associated with the rate plan. The rate plan functor may be stored in non-volatile or persistent memory and loaded into volatile memory. Alternatively, the rate plan functor may have already been loaded into volatile memory.

In a related embodiment, multiple rate plans may be applied to a single event. Thus, a single event may be passed to two or more rate plan functors for processing. For example, one rate plan may be for calculating a charge and another rate plan may be for calculating a discount to be applied to the calculated charge.

### “Sharing” Functors

Multiple rate plans may have many attributes in common. For example, multiple rate plans may have a “birthday rule” where, for example, if the day of an event initiated by a customer is the customer's birthday, then the customer is not charged for the corresponding usage. If each rate plan functor included its own instance of a “birthday” functor, then there may be multiple instances of the birthday functor. However, instead of generating a different instance of a “birthday” functor for each rate plan that includes a birthday rule, a single instance of the birthday functor is stored in memory and “shared” by multiple rate plan functors. Such an approach reduces the number of functor instances in a system and lowers the memory footprint of the event processing engine. In addition to singleton functions (such as a dayOfYear functor), non-singleton functors can also be shared. For example, TimeRange functors that take a start and end time, might have multiple instances of those functors shared across a rating system. Typically, many rate plans share the same peak period and off-peak period and, thus, can share the same instances of TimeRange functors (such as for off-peak represented by [19:00:00,07:00:00] and for peak represented by [07:00:00,19:00:00].

### Runtime Execution

In an embodiment, for each event that an event processing engine receives, a process or thread that handles the event determines the rate plan that corresponds to the event, identifies a rate plan functor that corresponds to the rate plan, and causes the rate plan functor to be executed. If it is determined that multiple rate plans correspond to the event, then multiple rate plan functors are identified and each rate plan functor is executed. The process or thread that may perform these steps is referred to herein as an “event processing thread,” which may be part of a single-threaded process or a multi-threaded process. In an embodiment where functors are immutable, it is completely thread-safe to evaluate a rate plan in a multi-threaded manner.

Although a binary tree model that represents a rate plan refers to a root functor, the result of parsing a DSL expression is a unique rate plan functor object. Once this functor is generated, evaluating the rate plan is as simple as calling F(X)=Y, where F is the rate plan functor, X is the event, and Y is the result (which may be a list of applicable charges). The order of invocation of the functors that compose the rate plan functor “F” is built-in the rate plan functor implementation. Once the rate plan functor is identified, the event processor “calls” the rate plan functor.

Because, in an embodiment, functors do not maintain state, there is no danger of data corruption or an incorrect result when multiple threads (e.g., that are involved in processing different events) execute a single instance of a particular functor.

In a sense, the event processing thread “blindly” evaluates the “equation” of the functor. The decision that determines which functor to execute next is delegated to operator functors that are part of the rate plan functor. Thus, an external system is not required to decide how to evaluate the rate plan. The functional logic is built-in in the rate plan functor itself. In other words, the rate plan functor itself contains the executable code whereas prior implementations of a rating engine rely on an external system to read data that represents a rate plan and perform operations based on that data. Thus, the functional rate plan model has a significant advantage over prior implementations of a rating engine.

### Memory Representation of a Rate Plan Functor

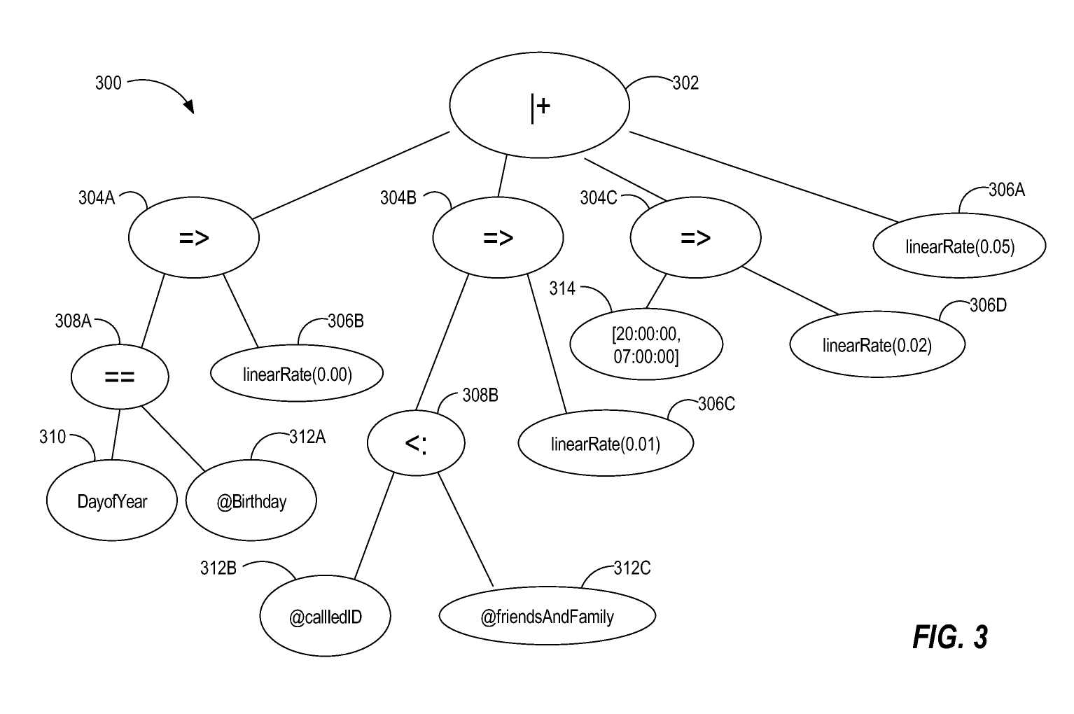

FIG. 3 is a block diagram that depicts an example memory representation 300 of a rate plan functor that comprises multiple functor, according to an embodiment of the invention. Representation 300 comprises numerous functors that represent different types of operations in a rate plan functor that corresponds to an example rate plan. Specifically, representation 300 includes an aggregator operator 302 (“|+”) that is directly connected to four functors: three if-then operators 304A-C (“=>”) and a rate functor 306A (“linearRate”) whose input is 0.05. If-then operator 304A is connected to an equality operator 308A (“==”) and a rate functor 306B whose input is 0.00. If equality operator 308A is true, then, according to if-then operator 304A, rate functor 306B is evaluated. The operands of equality operator 308A are a singleton operator 310 (“DayofYear”) and an alias operator 312A (“@Birthday”). Equality operator 308A evaluates to true if the person associated with an event that is being processed by this rate plan functor has a birthday on the same day as the day on which the event occurred. Otherwise, equality operator 308A evaluates to false.

If there is an additional amount of time or usage to be rated (as would be the case in this example if equality operator 308A evaluates to false), then if-then operator 304B is evaluated. If-then operator 304B is connected to a “within” operator 308B (“<:”) that has two operands: an alias operator 312B (“@calledID”) and alias operator 312C (“@friendsAndFamily”). This “branch” of the rate plan functor indicates that if the destination of a call is within the caller's set of friends and family, then the “then” portion of if-then operator 304B is evaluated. That “then” portion is rate functor 306C (“linearRate”), whose input is 0.01.

If there is an additional amount of time or usage to be rated (as would be the case in this example if within operator 308B evaluates to false), then if-then operator 304C is evaluated. If-then operator 304C is connected to a time range functor 314 ([ ]), whose input is 20:00:00 and 07:00:00, and rate functor 306D (“linearRate”) whose input is 0.02. This “branch” of the rate plan functor indicates that if at least a portion of service usage (e.g., a telephone call) is between the time of 8 PM and 7 AM, then that portion is rated by rate functor 306D, which rates that portion at 2 cents per minute.

If there is an additional amount of time or usage to be rated (which might be the case if the entire duration of usage was not evaluated by if-then operator 304C), then rate functor 306A is evaluated. Rate functor 306A (“linearRate”) takes 0.05 as input. This “branch” of the rate plan functor is evaluated if (1) the date of the telephone call is not the caller's birthday, (2) the destination of the call is not on the caller's friends and family list, and (3) at least part of the call occurred after 7 AM and before 8 PM.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

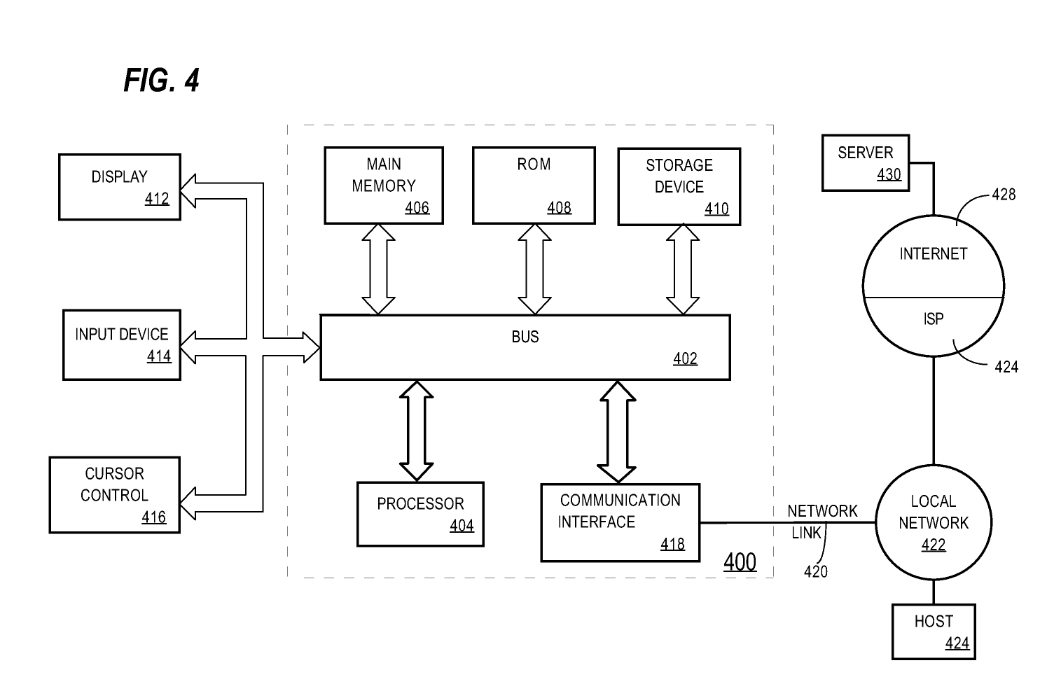

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
receiving an event, associated with a customer, at an event processing system;
in response to receiving the event:
identifying a rate plan functional object that comprises a plurality of functional objects;
executing the rate plan functional object, wherein executing the rate plan function object comprises:
executing a first functional object of the plurality of functional objects to generate a first result;
identifying, based on the first result, a second functional object of the plurality of functional objects;
executing the second functional object to generate a second result; and
based on the second result, determining an amount to charge the customer; and
updating, based on the amount, an account associated with the customer;
wherein the method is performed by one or more computing devices.

2. The method of claim 1, wherein less than all functional objects of the plurality of functional objects are executed to determine the amount.

3. The method of claim 1, wherein the steps of executing, identifying, and determining are performed by a single process.

4. The method of claim 1, wherein:
identifying a rate plan function object comprises identifying the rate plan functional object from among a plurality of rate plan functional objects.

5. The method of claim 1, further comprising:
receiving a statement that conforms to a domain specific language (DSL); and
processing the statement to generate the rate plan functional object.

6. The method of claim 5, further comprising:
receiving rule data that reflects a plurality of rules established by a user;
processing the rule data to generate the statement.

7. The method of claim 5, wherein the statement is reflected in input from a user.

8. The method of claim 1, wherein none of the functional objects in the rate plan functional object store state information after the account is updated.

9. The method of claim 1, further comprising:
storing, in association with a particular functional object in the rate plan functional object, a result of executing the particular functional object based on particular input to the particular functional object;
receiving a second event that is associated with a second customer; and
in response to receiving the second event, reading the result instead executing the particular functional object to generate the result.

10. The method of claim 1, wherein the event is a system event or a usage event that comprises usage data that indicates usage by the customer.

11. One or more non-transitory storage media storing instructions which, when executed by one or more processors, cause:
receiving an event, associated with a customer, at an event processing system;
in response to receiving the event:
identifying a rate plan functional object that comprises a plurality of functional objects;
executing the rate plan functional object, wherein executing the rate plan function object comprises:
executing a first functional object of the plurality of functional objects to generate a first result;
identifying, based on the first result, a second functional object of the plurality of functional objects;
executing the second functional object to generate a second result; and
based on the second result, determining an amount to charge the customer; and
updating, based on the amount, an account associated with the customer.

12. The one or more non-transitory storage media of claim 11, wherein less than all functional objects of the plurality of functional objects are executed to determine the amount.

13. The one or more non-transitory storage media of claim 11, wherein executing, identifying, and determining are performed by a single process.

14. The one or more non-transitory storage media of claim 11, wherein:
identifying a rate plan function object comprises identifying the rate plan functional object from among a plurality of rate plan functional objects.

15. The one or more non-transitory storage media of claim 11, wherein the instructions, when executed by the one or more processors, further cause:
receiving a statement that conforms to a domain specific language (DSL); and
processing the statement to generate the rate plan functional object.

16. The one or more non-transitory storage media of claim 15, wherein the instructions, when executed by the one or more processors, further cause:
receiving rule data that reflects a plurality of rules established by a user;
processing the rule data to generate the statement.

17. The method of claim 5, wherein the statement is reflected in input from a user.

18. The one or more non-transitory storage media of claim 11, wherein none of the functional objects in the rate plan functional object store state information after the account is updated.

19. The one or more non-transitory storage media of claim 11, wherein the instructions, when executed by the one or more processors, further cause:
storing, in association with a particular functional object in the rate plan functional object, a result of executing the particular functional object based on particular input to the particular functional object;
receiving a second event that is associated with a second customer; and
in response to receiving the second event, reading the result instead executing the particular functional object to generate the result.

20. The one or more non-transitory storage media of claim 11, wherein the event is a system event or a usage event that comprises usage data that indicates usage by the customer.
